(19) United States
(12) Patent Application Publication
(10) Pub. No.: US 2006/0007864 A1
(43) Pub. Date: Jan. 12, 2006

(54) Method and system of teleservice interworking of broadband heterogeneous networks

(76) Inventors: Ming Li, Shenzhen City (CN); Aijun Li, Shenzhen City (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/530,758

(22) PCT Filed: Jan. 8, 2003
(86) PCT No.: PCT/CN03/00014

§ 371 Date: Apr. 8, 2005

(30) Foreign Application Priority Data
Oct. 9, 2002 (CN) 02137406.6

(51) Int. Cl. H04L 12/26

(52) U.S. Cl. 370/238; 370/349

(57) ABSTRACT

The invention discloses a method and system of teleservice interworking of broadband heterogeneous networks. Said heterogeneous networks are connected by call control equipment and media interworking equipment, said call control equipment is used for signaling interworking and controlling the call that spans networks, said media interworking equipment is used for mapping the media port that spans networks and transmitting media streaming under the control of said call control equipment, said method comprising: receiving a call request coming from a caller party equipment by the call control equipment; determining by the call control equipment whether the call request of the caller party equipment is a call that spans heterogeneous networks; if said call request is a call that spans heterogeneous networks, then under the control of the call control equipment, creating connections between the media interworking equipment and the caller party equipment and between the media interworking equipment and a called party equipment; and transmitting the media streaming by the media interworking equipment and realizing media interworking.

### TECHNICAL FIELD OF THE INVENTION

The present invention relates to the field of telecommunication technology, more particularly, to the technology of teleservice interworking of broadband heterogeneous networks.

### BACKGROUND OF THE INVENTION

At present, in the new generation of an IP (i.e. Internet Protocol) telephone network, based on the idea to separate control and bearer, Media Gateway Controller (MGC for short) is thoroughly separated from Media Gateway (MG for short) both logically and physically. Various equipments, which can include traditional telephone equipments such as PSTN (public switched telephone network), ISDN (integrated services digital network) and PLMN (public lands mobile network), are accessed via different MGs, then a MGC is used to unitarily control these MGs, so as to facilitate the application of the new services, this has gradually become the development direction of the Next Generation Network (NGN for short). Among which, the control protocol between the MGC and the MG is a quite important link, which presently includes Media Gateway Control Protocol (MGCP for short) and H.248/Megaco protocol, etc.

However, broadband network is not a unified network. There are heterogeneous networks that have various different address planning and different network structures in existing broadband networks. Therefore, when different IP telephone users in different heterogeneous networks need to communicate with each other, for example, call to each other, the problem of network interworking will be encountered and communication between one another could not be realized if certain technical means and methods have not been taken.

A telecom network is a service network and the interworking of heterogeneous networks is different from the interworking of ordinary data networks. As the interworking of heterogeneous services networks, it relates to two aspects: one is the interworking of signaling, and the other is the interworking of media. For example, two telecom operators have unitarily planned their networks respectively. Then, respective network users can call to each other and accomplish various call services within their corresponding networks. However, because the two operators' networks have own architectures in network planning and address allocation etc., IP users belonging to respective operators could not communicate to one another, the call control equipment could not span two networks to establish a call, the media between two end points could not traverse the border of the network and interworking could not be realized.

At present, the interworking method of IP data networks, such as the technical solutions provided in U.S. Pat. No. 6,457,061 (Method and apparatus for performing internet network address translation) and U.S. Pat. No. 6,266,707 (System and method for IP network address translation and IP filtering with dynamic address resolution), is more suitable for a Client/Server manner, this unilaterally initiated manner only translates the address of an IP heading, it does not care and also could not understand the information of the application layer in a payload, therefore, it could not ensure the transparence of teleservice interworking, and could not resolve the requirement of end-to-end teleservice interworking between broadband heterogeneous networks. Also, at present, because various IP telephone protocols themselves have only describe call control and media gateway control, for the method of managing resources and implementing services, although the interworking model and method between a narrowband telephone network and a broadband telephone network has been specifically defined, the complete solution for teleservice interworking between broadband heterogeneous networks has not been provided.

### SUMMARY OF THE INVENTION

The technical problem to be solved by the invention is to provide a method and system for implementing teleservice interworking between broadband heterogeneous networks.

According to one aspect of the invention, there is provided a method of interworking teleservice between broadband heterogeneous networks, said heterogeneous networks are connected by call control equipment and media interworking equipment, said call control equipment is used for signaling interworking and controlling the call that spans heterogeneous networks, said media interworking equipment is used for mapping the media port that spans heterogeneous networks and transmitting media streaming under the control of said call control equipment, said method comprising: receiving a call request coming from a caller party equipment by the call control equipment; determining by the call control equipment whether the call request of the caller party equipment is a call that spans heterogeneous networks; if said call request is a call that spans heterogeneous networks, then under the control of the call control equipment, creating connections between the media interworking equipment and the caller party equipment, and also creating connections between the media interworking equipment and a called party equipment; and transmitting the media streaming by the media interworking equipment and realizing media interworking.

According to another aspect of the invention, it is provided a system of interworking teleservice between broadband heterogeneous networks, said system comprising: media interworking equipment connected between said heterogeneous networks for transmitting media streaming between said heterogeneous networks; call control equipment connected between said heterogeneous networks for processing call request that spans networks, transmitting signaling and controlling said media interworking equipment; under the control of said call control equipment, said media interworking equipment implements teleservice interworking between heterogeneous networks by establishing a media port corresponds to a caller party equipment and a media port corresponds to a called party equipment and mapping the two media ports.

### BRIEF DESCRIPTION OF THE DRAWINGS

It is believed that the above and other advantages, purposes and features of the present invention will be apparent from the following description of the preferred embodiments of the invention taken in conjunction with the accompanying drawings, in which:

FIG. 1 shows a diagram of a system of implementing teleservice interworking between broadband heterogeneous networks according to one embodiment of the invention;

FIG. 2 shows the structure of the call control equipment and the media interworking equipment in the system of implementing teleservice interworking according to one embodiment of the invention;

FIG. 3 shows a diagram of a system of implementing teleservice interworking when there are two pieces of call control equipment according to another embodiment of the invention;

FIG. 4 shows a diagram of a system of implementing teleservice interworking when there are two pieces of call control equipment and two pieces of media interworking equipment according to another embodiment of the invention;

FIG. 5 shows a structure diagram of implementing interworking with a H.323 network according to another embodiment of the invention;

FIG. 6 shows a structure diagram of implementing interworking with a SIP network according to another embodiment of the invention; and

FIG. 7 shows a flowchart of a method of implementing teleservice interworking between broadband heterogeneous networks according to one embodiment of the invention.

### DETAILED DESCRIPTION OF THE INVENTION

Next, specific implementations of the invention will be described in detail in conjunction with accompany drawings.

The interworking of broadband heterogeneous service networks relates to two aspects, one is the interworking of signaling, namely, a call signaling can traverse heterogeneous networks, and accomplish features such as control the call that spans networks and routing; and the other is the interworking of media, namely, on the basis that the call that spans heterogeneous networks has been established, implement media interworking for end users that belong to different networks such that the media streaming between different networks can mutually traverse the border of the heterogeneous networks. The media interworking is related to call control and is implemented by call control equipment controlling corresponding media interworking equipment.

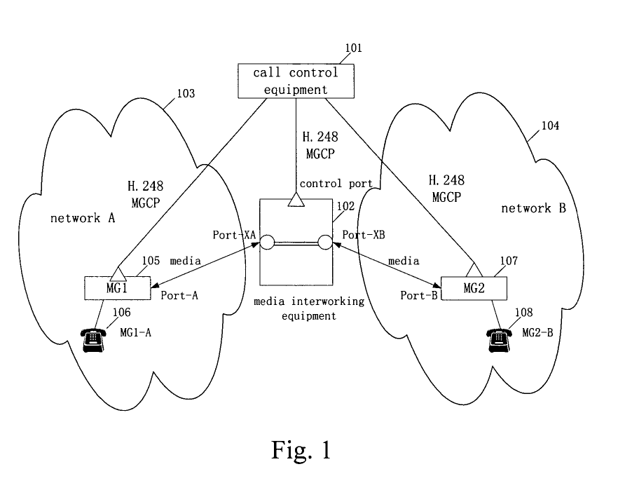

In view of the above two aspects, the present invention has proposed a system of implementing interworking, mainly it relates to two means, i.e. call control equipment and media interworking equipment. FIG. 1 shows a diagram of a system of implementing teleservice interworking between broadband heterogeneous networks according to one embodiment of the invention. In FIG. 1, network A103 and network B104 are two heterogeneous networks, such as the telecom networks of two telecom operators. User terminal MG1-A is connected to network A103 via media gateway MG1, user terminal MG2-B is connected to network B104 via media gateway MG2. Of course, there may be more user terminals and access equipment in network A103 and network B104.

Call control equipment 101 and media interworking equipment 102 are connected between the two networks 103 and 104, wherein call control equipment accomplishes signaling interworking and controls the call that spans networks, media interworking equipment 102 accomplishes mapping of media port that spans networks and transmits media streaming under the control of call control equipment 101. The above method of the invention complies with the architecture that separates services and networks and separates control and bearer.

Call control equipment 101 may be in a same network as an end user, or may be disposed in a network solely and independent of all end users. Call control equipment 101 can provide multiple logically independent network interface, they are respectively connected to multiple heterogeneous networks that interworking are needed. Call control equipment 101 performs call control, controls media gateway that pertains to it and controls signaling interworking of other call control equipment to implement call establish, call monitor, call release etc. that spans heterogeneous networks, while identifies and distinguishes call signaling coming into the equipment in order to process call signaling coming from different networks.

Media interworking equipment 102 is disposed between broadband heterogeneous networks and receives command from call control equipment in order to establish connections for two kinds of media ports within media interworking equipment, the two kinds of media ports corresponds to the media port of a caller, called end user coming from different networks, respectively. Thus, the media streaming coming from one network is converged into media interworking equipment 102 and transmitted to another network via the connection within the equipment. Logically, media interworking equipment 102 has two kinds of interface passage, one is signaling control interface and the other is media interface. There are two instances that media interworking equipment transmits the media streaming: one is mapping media port and transmit media streaming, namely, within the media interworking equipment, the media capability of the caller, called end user matches to each other such that there is no need to transform the format of the media; the other is that when the media capability of the caller and called end user does not match, media interworking equipment not only needs to establish mapping and connection for media port within the equipment, but also needs to transform the format of the media streaming coming into the equipment with related algorithm, such that the media capability of the caller and called end user will match to each other.

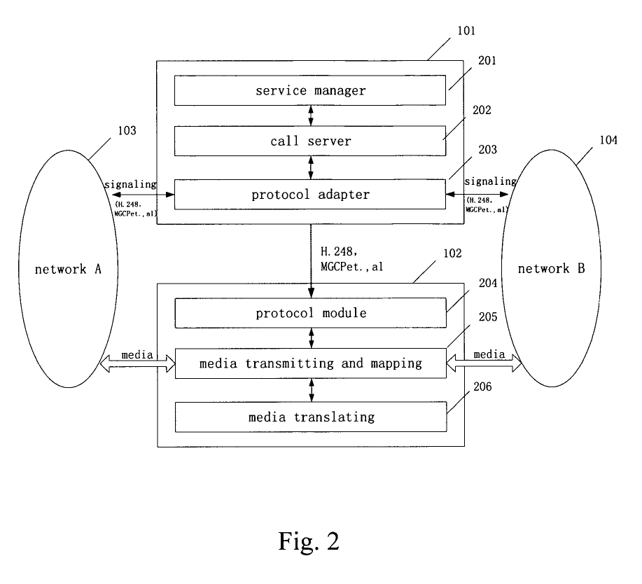

FIG. 2 shows the structure of the call control equipment and the media interworking equipment in the system of implementing teleservice interworking according to one embodiment of the invention. According to different embodiments of the invention, call control equipment 101 may be, for example, a soft switch, a media gateway controller and a call server etc.; media interworking equipment 102 may be a media gateway (MG).

As shown in FIG. 2, call control equipment 101 comprises service manager 201, call server 202 and protocol adapter 203. Protocol adapter 203 is used for transmitting the underlying data of the call control equipment 101, in particular, for sending and receiving data to and from other equipment according to corresponding network protocols and call control protocols, and transmitting received data relevant to service call to call server 202. The protocols used by protocol adapter 203 can comprise standard protocols such as H.248, MGCP, SIP, etc, that is used at present for transmitting media control data, or can also comprise other protocols that are able to accomplish transmitting of control data as well. Call server 202 is used for performing call control, including control the call that spans two heterogeneous networks.

Media interworking equipment 102 comprises protocol module 204, media transmitting and mapping unit 205, and media translation unit 206. Protocol module 204 is used for receiving control data from call control equipment 101, creating two media ports at media interworking equipment 102, such as Port-XA and Port-XB in FIG. 1 that corresponds to the heterogeneous networks at both sides respectively, and mapping the corresponding relationship of the media ports at both sides. Like protocol adapter 203, protocol module 204 can use standard protocol such as H.248, MGCP, SIP, etc. that is used at present for transmitting media control data, or can also use other protocols that are able to accomplish transmitting of control data as well to receive control data. Media transmitting and mapping unit 205 further transmits the media streaming coming into media interworking equipment 102 according to the established corresponding relationship. If the capability and format of the media at both sides do not match, then when transmitting media, there is additional need for media translation unit 206 to perform format translation for media streaming.

Referring to both FIGS. 1 and 2, from the viewpoint of a call, the call that spans heterogeneous networks is actually realized by being decomposed into multiple calls. From the viewpoint of a media connection, the media connection of a call is composed of multiple media connections. Typically, when a two-party call occurs between two networks and implements interworking via one piece of media interworking equipment 102, then the whole call is composed of two calls. The first call is established between a caller end user (e.g., user MG1-A for MG1) and the media interworking equipment 102, the second call is established between the media interworking equipment 102 and an end called user (e.g., user MG2-B for MG2). From the viewpoint of the network, a media connection is also divided into two segments, one is the connection from a caller terminal to the media interworking equipment 102 that corresponds to the media port for the caller party, the other is the connection from the media interworking equipment 102 to a called terminal that corresponds to the media port for the called party. Of course, if a call spans multiple networks, there will be more calls and media connections.

Media interworking equipment actually is purely media gateway and is only responsible for connection of pure media between heterogeneous networks, it does not care the establishment of the whole call, nor does it care that the media is composed of how many segments, call establish, call maintain, call release and the assignment of media port etc. are all accomplished by the call control equipment.

The present invention has no limitation to the call control equipment, the media interworking equipment and the control signaling/protocol employed by the party, what may be typically employed is H.248 or MGCP control protocol.

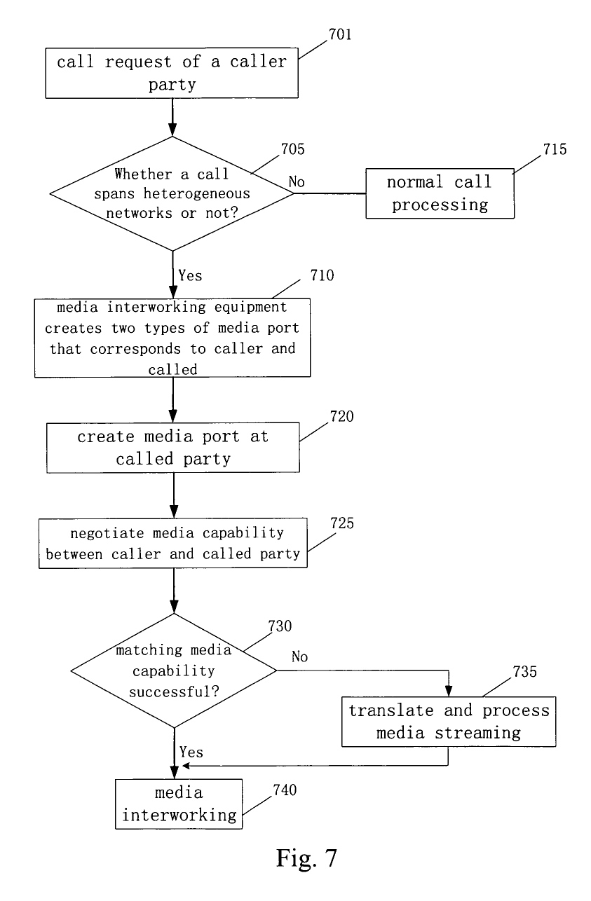

FIG. 7 shows a flowchart of a method of implementing teleservice interworking between broadband heterogeneous networks according to one embodiment of the invention. The method of implementing teleservice interworking between broadband heterogeneous networks according to the embodiment of the invention shown in FIG. 7 will be described.

As shown in FIG. 7, first at Step 701, a call request is sent by caller party equipment, the call request is received by call control equipment 101 and media is created within the caller party equipment.

Next at Step 705, a determination is made by the call control equipment 101 as to whether the call request of the caller party is a call that spans heterogeneous networks, if yes, then proceeding to Step 710, otherwise, to Step 715 to perform normal call processing.

At Step 710, two types of media ports are created by media interworking equipment 102 under the control of call control equipment 101 via signaling control interface, one corresponds to the media port of the caller party equipment, the media capability of that media port meets the requirement of the caller party equipment, the other corresponds to called party equipment;

Then at Step 720, the called party equipment is controlled by call control equipment 101, media port is created within the called party equipment and the correspondence between the called party equipment and the media port at the called side of the media interworking equipment is accomplished;

At Step 725, the negotiation for media capability of the caller party equipment and the called party equipment is accomplished. Because the caller and the called party equipment may support different media formats and media capabilities, for example, for voice services, different party equipment may sample with different sample schemes and process media streaming with different compress and transmit formats. Therefore, negotiation between the caller and the called party equipment is needed to find a media format that is supported by both parties. If found, then matching is successful; if not, then matching is unsuccessful and the media interworking equipment is needed to perform the translation process described in Step 735.

At Step 730, a determination is made as to whether the media capability of the caller, called party equipment is matched successfully, if the matching is successful, then proceeds to Step 740; otherwise, proceeds to Step 735.

At Step 735, media interworking equipment 102 will perform translation process for media streaming, in particular, media interworking equipment 102 will first decompress the incoming media streaming and recover it into original media streaming, then according to the needed format of the media, re-encode and compress the media streaming with standard DSP algorithm.

Finally, at Step 740, the media capability of the caller, called party is satisfied respectively by the media port corresponding to the caller, called side by the media interworking equipment to accomplish call establish, called party response and to realize media interworking.

The processing process of implementing teleservice interworking between broadband heterogeneous networks of the embodiment of the invention will be described in conjunction with FIG. 1 and will take user MG1-A calls user MG2-B as an example. As shown in FIG. 1, caller user MG1-A is in broadband network A, called user MG2-B is in broadband network B, and network A, B are the broadband networks that have been respectively planned. The caller party MG1-A of media gateway MG1 in network A picks up the phone to initiate a call request to called user MG2-B of media gateway MG2 in network B. A media port PORT-A is created for caller user MG1-A at MG1 and capability parameters such as address identification, port number and media codec etc. are configured. Call control equipment controls media interworking equipment to create two internal media ports via signaling control interface, one media port is PORT-XA, the other media port is PORT-XB, wherein PORT-XA meets the media capability requirement of PORT-A; a media port PORT-B is created for MG2-B user in MG2 and capability parameters such as address identification, port number and media codec etc. are configured, PORT-XB meets the media capability requirement of PORT-B. After media negotiation, the media passage from PORT-A to PORT-XA and from PORT-XB to PORT-B is completed, and media streaming interworking will be realized after called MG2-B has made a response.

The present invention is not limited to the case which has only one call control equipment and one media interworking equipment, the number of call control equipment can be two or more, and the number of media interworking equipment can also be two or more, the method of the invention also applies to the case that multiple call control equipment and media interworking equipment work simultaneously to cooperatively realize interworking of a call that spans broadband heterogeneous networks. When there are multiple call control equipment and multiple media interworking equipment:

1. Between call control equipment, cooperatively completing call control is realized via interworking signaling, the invention has no limitation to the signaling between call control equipment, typically is SIP-T (SIP for Telephones, i.e. session initiation protocol for telephones) or BICC (Bearer Independent Call Control);

2. Media interworking equipment will only accept the control of the call control equipment that control themselves respectively to complete mapping of media port and transmitting of media streaming;

3. Caller parties will only accept the control of the call control equipment which controlling themselves respectively.

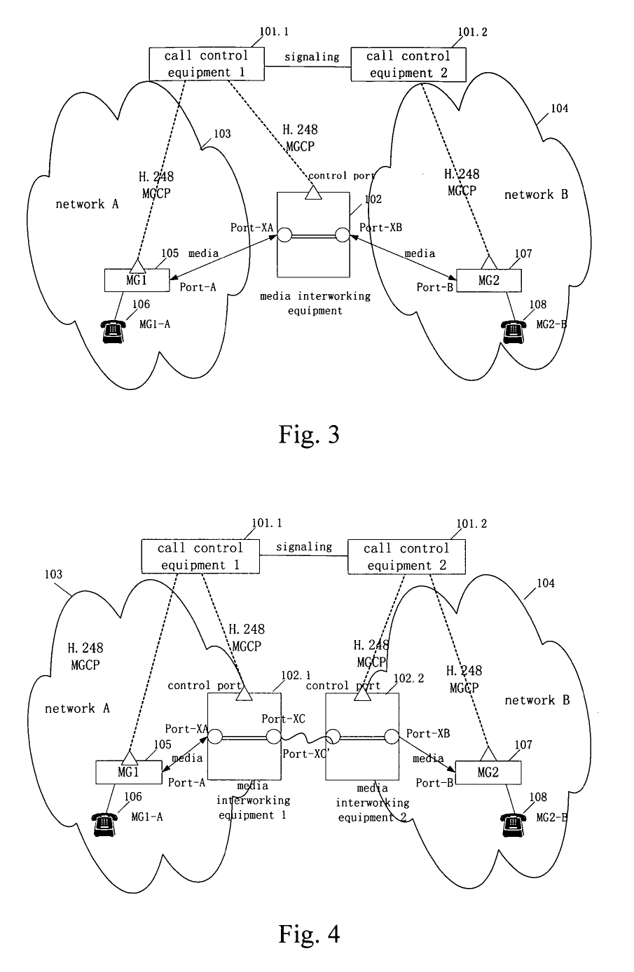

Next, other embodiments of the invention will be described in conjunction with FIG. 3 to 6. Here, same equipment and part are labeled with same number and the description of which will be omitted for brevity.

FIG. 3 shows a diagram of a system of implementing teleservice interworking when there are two pieces of call control equipment according to another embodiment of the invention. As shown in FIG. 3, the two pieces of call control equipment (101.1, 101.2) respectively control the end user that is under their control, wherein user MG1-A is controlled by call control equipment 101.1, and user MG2-B is controlled by call control equipment 101.2. One of the call control equipment, for example, call control equipment 101.1, is set to control media interworking equipment to realize media interworking that spans networks, between call control equipment, the whole call control that spans networks is cooperatively accomplished via interworking control signaling/protocol. Other process of implementation is the same as that described in FIG. 1.

FIG. 4 shows a diagram of a system of implementing teleservice interworking when there are two pieces of call control equipment and two pieces of media interworking equipment according to another embodiment of the invention. As shown in FIG. 4, the two pieces of call control equipment (101.1, 101.2) respectively control the end user that is under their control, the two pieces of media interworking equipment (102.1, 102.2) accomplish mapping and transmitting of media port under the control of corresponding call control equipment, then media streaming interworking is performed between the two pieces of media interworking equipment. Between call control equipment, the whole call control that spans networks is cooperatively accomplished via interworking signaling, wherein call control equipment 101.1 controls user MG1-A and media interworking equipment 102.1, call control equipment 101.2 controls user MG2-B and media interworking equipment 102.2, between call control equipment 101.1 and call control equipment 101.2, the whole call control that spans networks is cooperatively accomplished via interworking control signaling/protocol. Other process of implementation is the same as that described in FIG. 1.

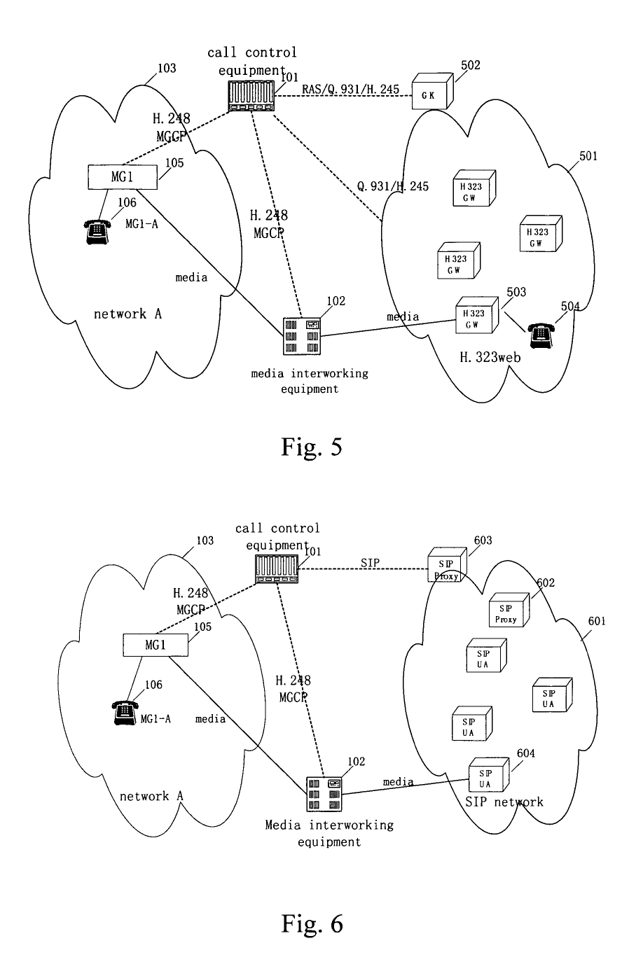

FIG. 5 shows a structure diagram of implementing interworking with a H.323 network according to another embodiment of the invention. Call control equipment 101 implements signaling interworking with a H.323 broadband network, responsible for initiating a RAS (remote access service) request to the gate keeper (GK for short) 502 of an opposite end H.323 network, interchanges Q.931 signaling with opposite end gate keeper GK 502 or gateway (GW), performs call control, establishes H.245 passage, negotiates media capability and media passage. Call control equipment 101 needs to support routing signaling by a GK and routing signaling directly by a gateway, when routing signaling by a GK, the signaling interchange between the call control equipment and the opposite end is all directly accomplished by call control equipment 101 via GK 502; when a gateway directly routes signaling, except that the RAS request toward GK 502 is initiated by call control, other H.323 signaling are all accomplished by call control equipment 101 directly interacting with the GW of an opposite end H.323 network. Media interworking equipment 102 accepts instructions of the call control equipment 101, establishes media passages that from end user at one side to media interworking equipment 102 and from media interworking equipment 102 to the media passage of the GW of a H.323 at other side, media streaming is connected and transmitted within interworking equipment 102.

FIG. 6 shows a structure diagram of implementing interworking with a SIP network according to another embodiment of the invention. Call control equipment 101 and an opposite end SIP proxy 603 employ SIP protocol to perform interworking and transmitting of call control signaling. Media interworking equipment 102 accepts instructions of the call control equipment 101, establishes media passages that from end user at one side to media interworking equipment 102 and from media interworking equipment 102 to a user proxy (e.g. SIP UA604) of the SIP network at other side, media streaming is connected and transmitted within interworking equipment 102.

It can be seen from the above description of the specific implementation of the invention that the main advantages of the invention are: the architecture of a next generation net that separates services from network and separates control from bearer has been realized; second, the way to implement networking is flexible, since media is separated from control, call control equipment and media interworking equipment can networking flexibly, such that one piece of call control equipment can implement call control to multiple networks, media interworking equipment can also implement media interworking between more than two networks; area of application is broad, it is applicable to interworking of teleservice between a public network and a private network and between different private networks, also, it does not only applicable to interworking of services between IP networks, but also between an IP network and an ATM network; at the same time, it satisfies the need to interworking and networking with traditional IP telephone network (e.g. H.323, SIP) equipment; also, it satisfies the requirement of multi-media services, realizes interworking of multi-media services between heterogeneous networks, since the media interworking equipment only relates to connection of pure media and is independent of the service itself, it is also applicable to heterogeneous multi-media networks.

Although the method disclosed that relates to implement teleservice interworking between broadband heterogeneous networks has been described in detail with reference to embodiments, those skilled in the art will appreciate that various apparent modifications in form and detail can be made without departing from the scope and spirit of the invention. Accordingly, the embodiments described above are illustrative and is not limitative, all changes and modifications are within the scope of the invention when not departing from the scope and spirit of the invention.

1. A method of interworking teleservice between broadband heterogeneous networks, said heterogeneous networks are connected by call control equipment and media interworking equipment, said call control equipment is used for signaling interworking and controlling call that spans networks, said media interworking equipment is used for mapping media port that spans networks and transmitting media streaming under the control of said call control equipment, said method comprising:
receiving a call request coming from a caller party equipment by the call control equipment;
determining by the call control equipment whether the call request of the caller party equipment is a call that spans heterogeneous networks;
creating connections between the media interworking equipment and the caller party equipment and between the media interworking equipment and a called party equipment under the control of the call control equipment if said call request is a call that spans heterogeneous networks; and transmitting media streaming by the media interworking equipment and realizing media interworking.

2. The method according to claim 1, wherein, said step of creating connection comprising:
creating media port within the caller party equipment;
creating media port that corresponds to the caller party equipment and media port that corresponds to the called party equipment within the media interworking equipment; and
creating media port within the called party equipment.

3. The method according to claim 1, wherein, before the step of transmitting media streaming, said method further comprising:
negotiating media capability with the called party equipment by the caller party equipment;
translating the format of the media streaming by the media interworking equipment if matching of the media capability of the caller/called party equipment is unsuccessful.

4. The method according to claim 3, wherein, said step of translating the format of the media streaming comprising:
recovering incoming media streaming into original media streaming;
re-encoding and compressing the media streaming according to the needed format of the media.

5. The method according to claim 1, wherein, said call control equipment sends and receives control signaling via H.248 or MGCP protocol.

6. The method according to claim 1, wherein, two or more pieces of call control equipment are connected between said heterogeneous networks, and each of said two or more pieces of call control equipment controls different party equipment respectively, said method further comprising:
transmitting a call request by the call control equipment that controls the caller party equipment to the call control equipment that controls the called party equipment;
designating one piece of call control equipment to control the media interworking equipment.

7. The method according to claim 6, wherein, signaling is transmitted between the call control equipment via session initiation protocol for telephones or bearer independent call control protocol.

8. The method according to claim 1, wherein, two or more pieces of media interworking equipment are connected between said heterogeneous networks, and each of said two or more pieces of media interworking equipment is connected to a different network respectively, said method further comprising:
establishing a media connection between the media interworking equipment connected to the caller party equipment's network and the media interworking equipment connected to the called party equipment's network.

9. The method according to claim 1, wherein, one of said heterogeneous networks is a H.323 network and that H.323 network has a gate keeper and a H.323 gateway therein; the connection between said media interworking equipment and the party equipment in said H.323 network is established by the call control equipment and by the gate keeper that controls the H.323 gateway.

10. The method according to claim 1, wherein, one of said heterogeneous networks is a SIP network and that SIP network has a SIP proxy and a SIP user agent therein; the connection between said media interworking equipment and the party equipment in said SIP network is established by the call control equipment and by the SIP proxy that controls the SIP user agent.

11. A system of interworking teleservice between broadband heterogeneous networks, comprising:
a piece of media interworking equipment connected between said heterogeneous networks for transmitting media streaming between said heterogeneous networks;
a piece of call control equipment connected between said heterogeneous networks for processing call request that spans networks, transmitting signaling and controlling said media interworking equipment;
the media interworking equipment implements teleservice interworking between heterogeneous networks by establishing a media port that corresponds to caller party equipment and a media port that corresponds to called party equipment and mapping the two media ports under the control of said call control equipment.

12. The system according to claim 11, wherein, said media interworking equipment comprising:
a protocol module for receiving control data from said call control equipment, creating said media ports and establishing correspondence relationship of said media ports;
a media transmitting and mapping unit for transmitting media streaming that comes into the media interworking equipment according to said established correspondence relationship.

13. The system according to claim 12, wherein, said media interworking equipment further comprising:
a media translating unit for processing format translation for the media streaming when the media capability or format at both sides does not match.

14. The system according to claim 11, wherein, said call control equipment comprising:
a protocol adapter for receiving and sending control data and receiving call request coming from party equipment;
a call server 202 for controlling call that spans said heterogeneous networks.
